(19) United States
(12) Patent Application Publication
(10) Pub. No.: US 2010/0128821 A1
(43) Pub. Date: May 27, 2010

(54) SIGNAL DEMODULATION METHOD BASED ON DVB-S2

(75) Inventors: Pan-soo Kim, Daejeon-si (KR); Dae-ig Chang, Daejeon-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/506,515

(22) Filed: Jul. 21, 2009

(30) Foreign Application Priority Data
Nov. 24, 2008 (KR) 10-2008-0117066

(51) Int. Cl. H04L 27/06

(52) U.S. Cl. 375/340; 370/350

(57) ABSTRACT

A satellite broadcasting frame signal demodulation method is disclosed. A demodulation method of a demodulator that demodulates a Digital Video Broadcasting-Satellite—Second Generation (DVB-S2) standard satellite broadcasting frame signal includes: performing symbol synchronization; performing frame synchronization after symbol synchronization; recovering a carrier wave after frame synchronization; and decoding mode code (MODCOD) information to obtain frame configuration information after recovering the carrier wave. This method ensures rapid demodulation and reliable demodulated data.

### CROSS-REFERENCE TO RELATED APPLICATION

This application claims the benefit under 35 U.S.C. §119(a) of Korean Patent Application No. 10-2008-117066, filed on Nov. 24, 2008, the disclosure of which is incorporated herein in its entirety by reference.

### BACKGROUND

1. FIELD

The following description relates to demodulation technology, and more particularly, to frame signal demodulation technology in a transmission structure of a Digital Video is Broadcasting-Satellite—Second Generation (DVB-S2) system.

2. Description of the Related Art

In a DVB-S2 system, in order to maximize transmission efficiency, an Adaptive Coding and Modulation (ACM) method is used. In the ACM method, an optimal coding method and modulation rate are variably or adaptively selected according to channel state. By using this method, reception or linking of data by each receiver in a satellite broadcasting and telecommunication system is variably or adaptively controlled according to radio wave conditions, and thus it is possible to improve transmission capacity.

In the ACM transmission method, a channel adaptive transmission method appropriate for a point-to-point communication environment, there is a single transmission route, a transmission environment is determined by limitation to a channel state of a transmission/reception region, and a transmission channel can be secured by selection of an optimal modulation method. However, in a broadcasting environment, since a reception region is wide and a channel environment of the reception region varies, the adaptive modulation method based on the same transmission method is not capable of satisfying the communication environment of every region. Accordingly, in a broadcasting environment, various transmission methods are transmitted by time division, and in a receiver, transmission frames employing Variable Coding and Modulation (VCM), which can select an optimal modulation method for the transmission channel environment, are proposed, so that reliable broadcasting can be reproduced adaptively with respect to channel state.

In such a DVB-S2 system, a receiver, in order to obtain 5-bit MODCOD information, 1-bit frame length information, and 1-bit pilot existence information, acquires 7 bits of information using Reed Muller (RM) decoding technology (64,7). Alternatively, it obtains 6 most significant bits (MSBs) using RM (32,6), and then obtains 1-bit information through repeated/reverse confirmation. However, this RM decoding technology cannot obtain accurate information after signal demodulation is complete. That is, when there is an error in a carrier wavelength, it is impossible to obtain accurate information. Moreover, if the above 7 bits of information cannot be obtained in a cold start state, which is an initial mode of demodulation, then descrambling and recognition of pilot location information cannot be carried out, which makes it difficult to employ a pilot symbol for signal demodulation.

### SUMMARY

The following description relates to technology for ensuring reliability of demodulation data in a VCM/ACM mode.

According to an exemplary aspect, there is provided a demodulation method of a demodulator that demodulates a DVB-S2 standard satellite broadcasting frame signal, the method including: performing symbol synchronization; performing frame synchronization after symbol synchronization; recovering a carrier wave after frame synchronization; and decoding mode code (MODCOD) information to obtain frame configuration information after recovering the carrier wave.

In recovering the carrier wave, the carrier wave may be recovered using a start of frame symbol.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 illustrates an example of a physical layer (PL) frame signal stream when VCM/ACM is employed in a DVB-S2 system.

FIG. 2 is a table of symbol separation information for detecting mode identification (MOD ID), frame type, and pilot existence.

FIG. 3 illustrates the constitution of an exemplary DVB-S2 demodulator.

FIG. 4 is a graph of RM decoding performance versus doppler frequency error.

FIG. 5 is a flowchart of signal demodulation for VCM/ACM.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Like reference numerals in the drawings denote like elements.

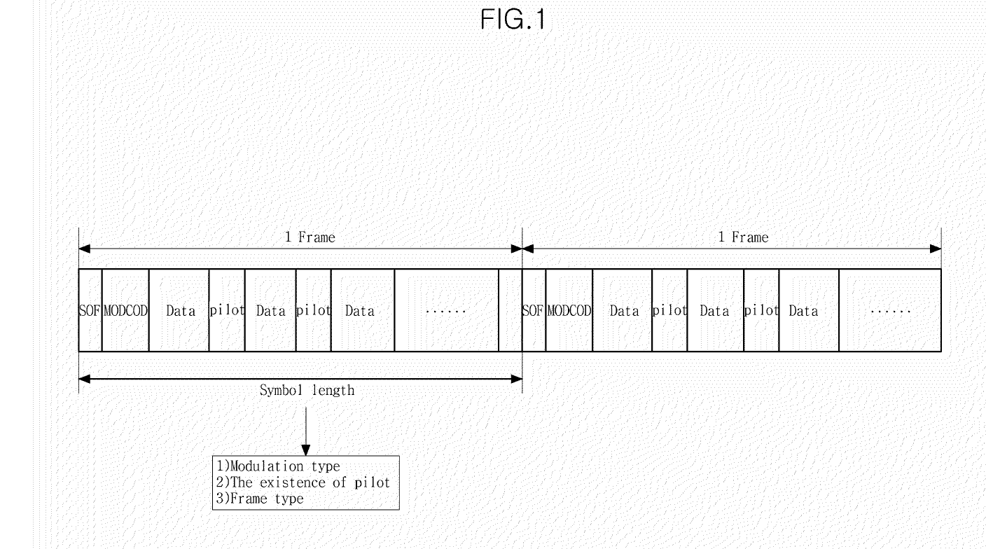

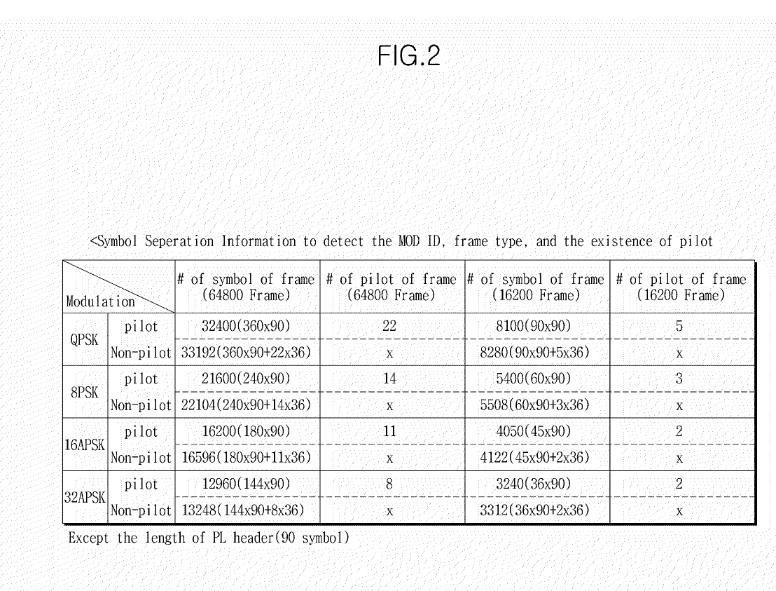

FIG. 1 illustrates the structure of a DVB-S2 physical layer frame (PLFRAME), and FIG. 2 is a table of symbol separation information for detecting mode identification (MOD ID), frame type, and existence of a pilot.

A start of frame (SOF) block, which is a frame used for frame synchronization in the DVB-S2 standard, is comprised of 26 symbols of a set bit pattern. A modulation and coding configuration (MODCOD) block is comprised of 7 bits, including 5 bits of modulation type and coding rate information, 1 bit of frame length information, and 1 bit of with/without pilot information. These 7 bits include a total of 64 symbols when (32,6) RM encoding is performed and then repeated/reverse π/2 BPSK modulation is performed on the last 1 bit that indicates the existence of a pilot. A DATA block, which expresses data information, is formed of 16 slots which are each formed of 90 symbols, for a total of 1440 symbols. A PILOT block has 36 symbols of pilot data information inserted into it.

In the case of constant coding and modulation (CCM), a fixed length PL frame is transmitted. However, in the case of VCM/ACM transmission, data is transmitted in PL frame lengths of 16 different modes. Also, depending on coding rate information, while PL frame length is the same, channel decoding has to be performed at different coding rates.

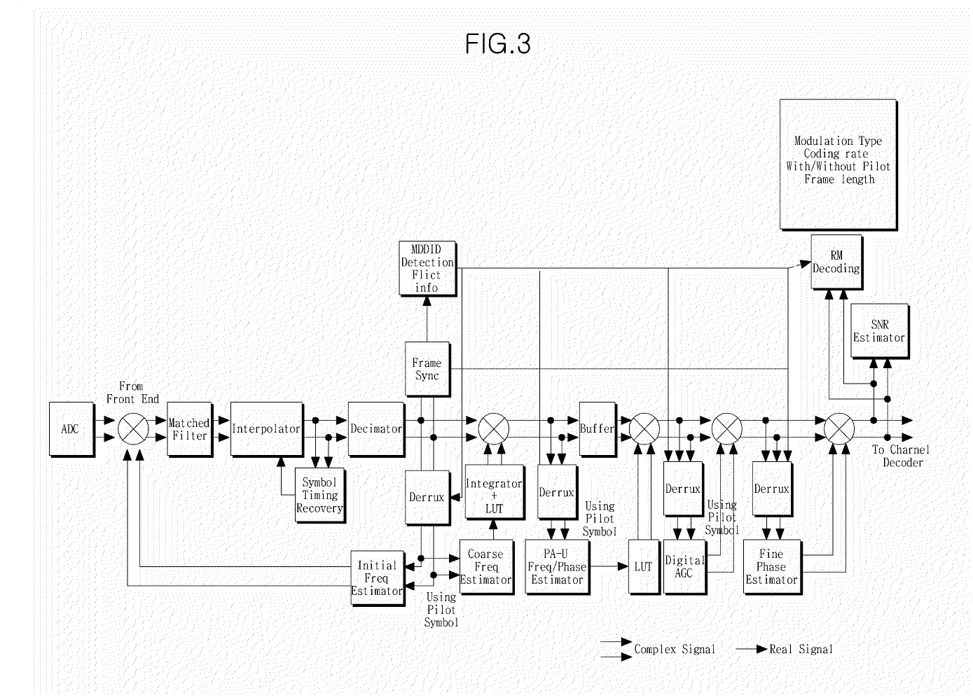

FIG. 3 illustrates the constitution of an exemplary DVB-S2 demodulator.

A received signal of an ADC output undergoes symbol timing synchronization, frame synchronization, wavelength synchronization, phase synchronization, etc. and is demodulated. In a final process, before data is handed over for FEC decoding, coding rate information and frame length information are acquired through RM decoding and transferred. In the particular case of VCM/ACM demodulation and decoding, new coding rate information and frame length information has to be transferred for each PL frame. Accordingly, an RM decoding result value has to be accurate in order to enable accurate data decoding, and for accurate RM decoding, first, signal carrier wave error has to be recovered.

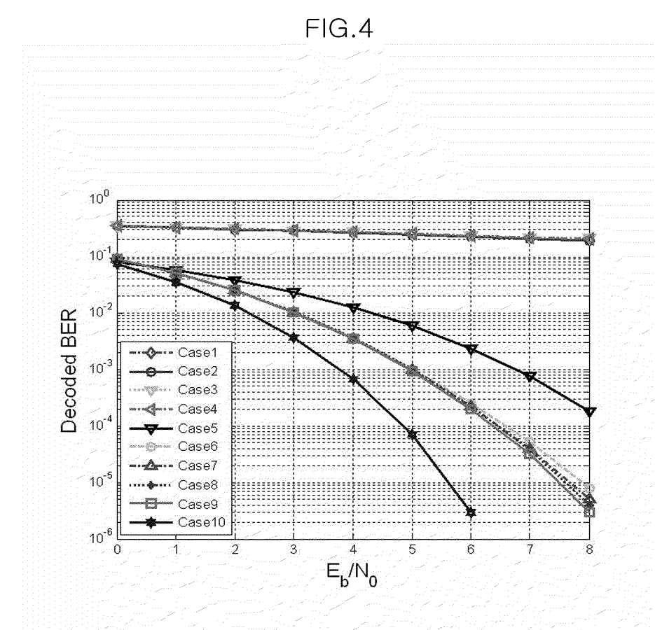

FIG. 4 is a graph of RM decoding performance versus Doppler frequency error.

Ten cases of channel environment are as follows:
Uncoded, Additive White Gaussian Noise (AWGN)
   Case 1
Physical Layer Signaling Code (PLSC) Decoding, Rayleigh fading
   Case 2: f_{d,norm}=1.56×10⁻⁵ (f_{c}=21 GHz, BW=25 MHz, v=20 km/h)
   Case 3: f_{d,norm}=1.78×10⁻⁴ (f_{c}=12 GHz, BW=25 MHz, v=400 km/h)
   Case 4: f_{d,norm}=3.11×10⁻⁴ (f_{c}=21 GHz, BW=25 MHz, v=400 km/h)
   Case 5: f_{d,norm}=1.56×10⁻³ (f_{c}=21 GHz, BW=5 MHz, v=400 km/h)
PLSC Decoding, Rician fading (K=15 dB)
   case 6: f_{d,norm}=1.56×10⁻⁵ (f_{c}=21 GHz, BW=25 MHz, v=20 km/h)
   Case 7: f_{d,norm}=1.78×10⁻⁴ (f_{c}=12 GHz, BW=25 MHz, v=400 km/h)
   Case 8: f_{d,norm}=3.11×10⁻⁴ (f_{c}=21 GHz, BW=25 MHz, v=400 km/h)
   Case 9: f_{d,norm}=1.56×10⁻³ (f_{c}=21 GHz, BW=5 MHz, v=400 km/h)
PLSC Decoding, AWGN
   Case 10

Each of Cases 1-10 shows different RM decoding performance with respect to channel environment. In particular, in cases 2, 3, and 4, RM decoding performance reaches an error floor, and in cases 6, 7, and 8 as well, Eb/No coding gain degradation can be seen. Accordingly, to reduce performance degradation of an RM decoder, carrier wave recovery and channel estimation must be made a top priority.

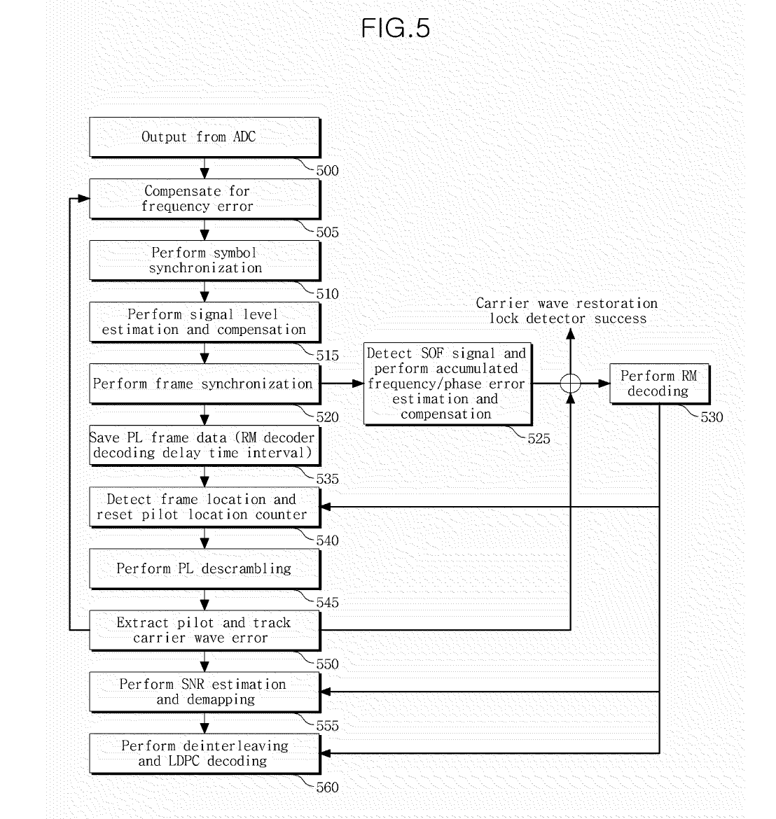

FIG. 5 is a flowchart of signal demodulation for VCM/ACM.

A demodulator passes a received signal that has been down-converted to an intermediate frequency (IF) and then again converted to a baseband through an ADC. Next, frequency error with respect to all frames of the ADC output signal is compensated for, and symbol synchronization is performed (S500, S505, and S510). Here, symbol synchronization means adjustment of clock timing of symbol rows of the signal so as to find a point of optimal signal to noise ratio (SNR) in the symbol domain. After performing symbol synchronization, signal level estimation and compensation are performed (S515). Next, frame synchronization is performed using a PL header to an optimal sampling value, and RM decoding is performed using MODCOD information comprised of 64 symbols after SOF to obtain frame configuration information (S520 and S530).

During a delay time interval for decoding in the RM decoder, a PL frame is saved (S535). Subsequently, when RM decoding is finished, a frame structure is detected from the decoding result, and a pilot location count is reset (S540). Next, PL frame descrambling, pilot extraction, and carrier wave error tracking are performed (S545 and S550). An SNR is estimated, and demapping is performed (S555). Next, deinterleaving and low density parity check (LDPC) decoding are performed (S560).

Meanwhile, according to an aspect of the present disclosure, before RM decoding, carrier wave recovery is repeatedly performed using SOF symbols (S525). That is, accumulated frequency/phase error is estimated and compensated for. Preferably, the RM decoder recovers the carrier wave by the size of frequency error that can be decoded, i.e., repeatedly performs carrier wave recovery until a remaining frequency error is small enough for MODCOD information decoding. In this case, if a carrier wave recovery lock detector is enabled, information is extracted and data is transferred to each descrambler, place for extracting pilot location, and demapper to perform feedforward demodulation without PL frame delay.

In summary, in performing demodulation according to the above disclosure, if SOF location and pilot symbol location information are known, especially in the case of a low SNR environment and a large frequency error, then carrier frequency recovery helps to enable rapid and accurate removal of carrier frequency error.

When obtaining frame length information from frame synchronization, although one among the sixteen of FIG. 2 can be found, it is only possible in the case of CCM transmission. Moreover, after final PL frame demodulation, when data is demapped into soft information to be transferred to an LDPC decoder, demodulation method, frame length, and coding rate information have to be provided. To this end, RM decoding (MODCOD 5-bit information decoding, frame length 1-bit information decoding, with/without pilot 1-bit information decoding) has to be performed, but to be successful, remaining frequency error has to be about 0.03% of a symbol speed.

Accordingly, in the present invention, a SOF symbol is employed to perform continuous initial carrier wave recovery, a carrier wave recovery lock detector performs recovery when a frequency error is less than 0.03% (starting from a time when RM coding is possible) to obtain 7 bits of information, PL descrambling is performed, and carrier wave recovery is utilized when there is a pilot symbol.

It will be apparent to those skilled in the art that various modifications and variations can be made in the present invention without departing from the spirit or scope of the invention. Thus, it is intended that the present invention covers the modifications and is variations of this invention provided they come within the scope of the appended claims and their equivalents.

What is claimed is:

1. A demodulation method of a demodulator that demodulates a digital video broadcasting-satellite—second generation (DVB-S2) standard satellite broadcast frame signal, the method comprising:
performing symbol synchronization;
performing frame synchronization after the symbol synchronization;
recovering a carrier wave after the frame synchronization; and
decoding mode code (MODCOD) information to obtain frame configuration information after completion of carrier wave recovery;

2. The method of claim 1, wherein the satellite broadcast frame signal is an Adaptive Coding and Modulation technique signal.

3. The method of claim 1, wherein the satellite broadcast frame signal is a Variable Coding and Modulation technique signal.

4. The method of claim 1, wherein restoring the carrier wave comprises continuously restoring the carrier wave using a start of frame (SOF) symbol.

5. The method of claim 4, wherein restoring the carrier wave comprises repeatedly restoring the carrier wave until a remaining carrier wave error is small enough to enable MODCOD information decoding.
